(19) United States
(12) Patent Application Publication
(10) Pub. No.: US 2007/0237190 A1
(43) Pub. Date: Oct. 11, 2007

(54) High-power Er: YAG laser

(75) Inventors: Shogo Yoshikawa, Tokyo (JP); Hiroshi Miura, Yokohama-shi (JP)

Correspondence Address: YOUNG & THOMPSON, 745 SOUTH 23RD STREET, 2ND FLOOR, ARLINGTON, VA, 22202, US

(73) Assignees: TOEI INDUSTRY, CO., LTD., TOKYO (JP); LEMI CO., LTD., YAMATO-SHI (JP)

(21) Appl. No.: 11/651,516

(22) Filed: Jan. 10, 2007

(30) Foreign Application Priority Data
Jan. 18, 2006 (JP) 2006-010326

(51) Int. Cl. H01S 3/30; H01S 3/16; H01S 3/093

(52) U.S. Cl. 372/4; 372/72; 372/41

(57) ABSTRACT

An Er:YAG laser includes an Er:YAG crystal medium and optical pumping element and is adapted to oscillate at a wavelength of 2.94 μm. The optical pumping element irradiates pumping light pulses onto a plurality of regions along a longitudinal direction of the Er:YAG crystal medium from its side at timings offset from each other, thereby exciting the respective regions. By exciting the spatial regions of the laser medium in a time-sharing manner, Er ions in an unexcited region of a 4I_{13/2} level serving as a lower level in the 2.94 μm-wavelength laser are reduced by a non-radiation process and, therefore, it is possible to achieve the increase in power of the 2.94 μm-wavelength laser output of the Er:YAG laser.

This application claims priority to prior Japanese Patent Application No. 2006-10326, the disclosure of which is incorporated herein by reference in their entirety.

### BACKGROUND OF THE INVENTION

This invention relates to an Er:YAG laser and, in particular, relates to increasing the power of laser light having an oscillation wavelength of 2.94 μm.

As oscillation wavelengths of Er:YAG lasers, 1.55 μm and 2.94 μm are well known. 1.55 μm-wavelength laser light is mainly used in the field of optical communication, while 2.94 μm-wavelength laser light is used in the field of dental treatment. 2.94 μm-wavelength laser equipment uses a flashlamp as an excitation source and generate short-time pulses with a laser oscillation duration of about 250 μsec at a maximum repetition rate of about 10 Hz, wherein the average power normally amounts to about 4 W.

If it becomes possible to achieve an increase in power of 2.94 μm-wavelength lasers by high-repetition pulse oscillation or high-power quasicontinuous oscillation, since this wavelength corresponds to the peak of the water absorption spectrum, applications are expected not only to the field of medical treatment such as dental treatment, but also to industrial machining and processing fields.

An Er:YAG energy level diagram has features of both a ruby laser typical of a three-level laser and a Nd:YAG laser typical of a four-level laser. Since the gain is very small, the Er:YAG laser is used by increasing the content of Er ions to about 50%.

1.55 μm-wavelength laser oscillation is that of a three-level laser caused by transition from the 4I_{13/2} level to the 4I_{15/2} ground level, while 2.94 μm-wavelength laser oscillation is that of a four-level laser caused by transition from the 4I_{1/2} level to the 4I_{13/2} level. The fluorescence lifetime of the lower level 4I_{13/2} in the 2.94 μm-wavelength laser oscillation is 4 msec and thus is far longer than a fluorescence lifetime 200 μsec of the upper level 4I_{1/2}. This difference in lifetime makes it difficult to maintain the inversion of population numbers (negative temperature distribution) between both levels, which is the essential condition for the 2.94 μm-wavelength laser oscillation.

However, it is reported that since the content of Er ions in a YAG rod is large, energy is given and received between energy levels including the excited levels due to interaction between Er ions and hence the actual fluorescence lifetime of the lower level is significantly shortened. As described above, pulse lasers for dental treatment are actually available and there is observed continuous oscillation with an output power of about 1 W caused by laser diode excitation.

However, the high-power high-repetition pulse oscillation or the high-power quasicontinuous oscillation has not been achieved up to now. This is because it is considered that the fluorescence lifetime of the lower level (4I_{13/2}) in the 2.94 μm laser transition is longer than that of the upper level (4I_{11/2}) and thus the inverse distribution of population numbers cannot be maintained between the laser oscillation levels.

For further information, see Walter Koechner, “Solid-State Laser Engineering, Fifth Revised and Updated Edition”, Springer-Verlag, 1999, page 374 (Non-Patent Document 1) and A. Charlton, M. R. Dickinson and T. A. King, “High repetition rate, high average power Er:YAG laser at 2.94 μm”, Journal of Modern Optics, 1989, vol. 36, No. 10, pp. 1393-1400 (Non-Patent Document 2).

### SUMMARY OF THE INVENTION

It is therefore an object of this invention to increase the power of 2.94 μm-wavelength laser light in an Er:YAG laser and to provide an Er:YAG laser equipment that enables high-power high-repetition pulse oscillation or high-power quasicontinuous oscillation.

According to this invention, there is obtained an Er:YAG laser equipment comprising an Er:YAG crystal medium and optical pumping means and adapted to oscillate at a wavelength of 2.94 μm, wherein the optical pumping means irradiates pumping light pulses onto a plurality of regions of the Er:YAG crystal medium from its side at timings offset from each other, the plurality of regions located along a longitudinal direction of the Er:YAG crystal medium.

Preferably, the timings of the pumping light pulses are offset from each other such that the pumping light pulses do not overlap each other.

Further, the pumping light pulses having a predetermined period are irradiated onto the plurality of regions of the Er:YAG crystal medium, respectively.

Preferably, the pumping light pulses are irradiated onto the plurality of regions of the Er:YAG crystal medium in a time-sharing manner, respectively.

According to one aspect of this invention, the plurality of regions of the Er:YAG crystal medium include Er:YAG rods, respectively, and the optical pumping means comprises optical pumping sources corresponding to the Er:YAG rods, respectively.

As the optical pumping means, use can be made of a Xe flashlamp adapted to perform pulse discharge operation. Further, as the optical pumping means, use can be made of a pulse-driven semiconductor laser array.

Further, according to this invention, there is obtained an Er:YAG laser equipment comprising an Er:YAG crystal medium and optical pumping means and adapted to oscillate at a wavelength of 2.94 μm, wherein Er:YAG laser light having a wavelength of 1.55 μm is injected into the Er:YAG crystal medium from a laser-oscillation axial direction.

Further, according to this invention, there is obtained an Er:YAG laser equipment comprising an Er:YAG crystal medium, optical pumping means, and a first and a second reflection mirror disposed at opposite ends of the Er:YAG crystal medium, the Er:YAG laser adapted to oscillate at a wavelength of 2.94 μm, wherein the first and second reflection mirrors form a resonator with respect to the wavelength of 2.94 μm and a wavelength of 1.55 μm and laser light having the wavelength of 2.94 μm is output from the second reflection mirror.

In this invention, since Er ions in a level 1 serving as a lower level of a 2.94 μm-wavelength laser are reduced through a spontaneous light emission process and another relaxation process or through a stimulated light emission process, it is possible to achieve an increase in power of 2.94 μm-wavelength laser output of an Er:YAG laser.

According to one mode of this invention, by exciting spatial regions of a laser medium in a time-sharing manner, Er ions in an unexcited region of a 4I_{13/2} level serving as a lower level of a 2.94 μm-wavelength laser can be reduced through a spontaneous light emission process and another relaxation process to thereby enable recovery and preparation for the next oscillation and, therefore, the average power of 2.94 μm-wavelength laser output of an Er:YAG laser can be increased.

According to another mode of this invention, since Er ions in a 4I_{13/2} level serving as a lower level in a 2.94 μm-wavelength laser are reduced through a stimulated light emission process using 1.55 μm-wavelength light wherein the 4I_{13/2} level serves as an upper level, it is possible to achieve an increase in power of 2.94 μm-wavelength laser output of an Er:YAG laser.

### BRIEF DESCRIPTION OF THE DRAWINGS

FIG. 1 is a schematic diagram of an Er:YAG laser device according to a first embodiment of this invention;

FIG. 2 is a timing chart showing the output of the Er:YAG laser equipment shown in FIG. 1;

FIG. 3 is a schematic diagram of an Er:YAG laser equipment according to a second embodiment of this invention;

FIG. 4 is a cross-sectional view of an LD-excited laser housing used in the second embodiment of this invention;

FIG. 5 is a schematic diagram of an Er:YAG laser according to a third embodiment of this invention;

FIG. 6 is a perspective view of an LD array assembly used in the third embodiment of this invention;

FIG. 7 is a schematic diagram of an Er:YAG laser according to a fourth embodiment of this invention;

FIG. 8 is a schematic diagram of an Er:YAG laser according to a fifth embodiment of this invention;

FIGS. 9A and 9B are diagrams respectively showing the relationships each between reflectance of a reflection mirror and wavelength, wherein the reflection mirrors form a resonator and are used in the fifth embodiment of this invention; and

FIG. 10 is an energy diagram of Er ions in Er:YAG crystals.

### DESCRIPTION OF THE PREFERRED EMBODIMENT

Now, embodiments of this invention will be described with reference to the drawings.

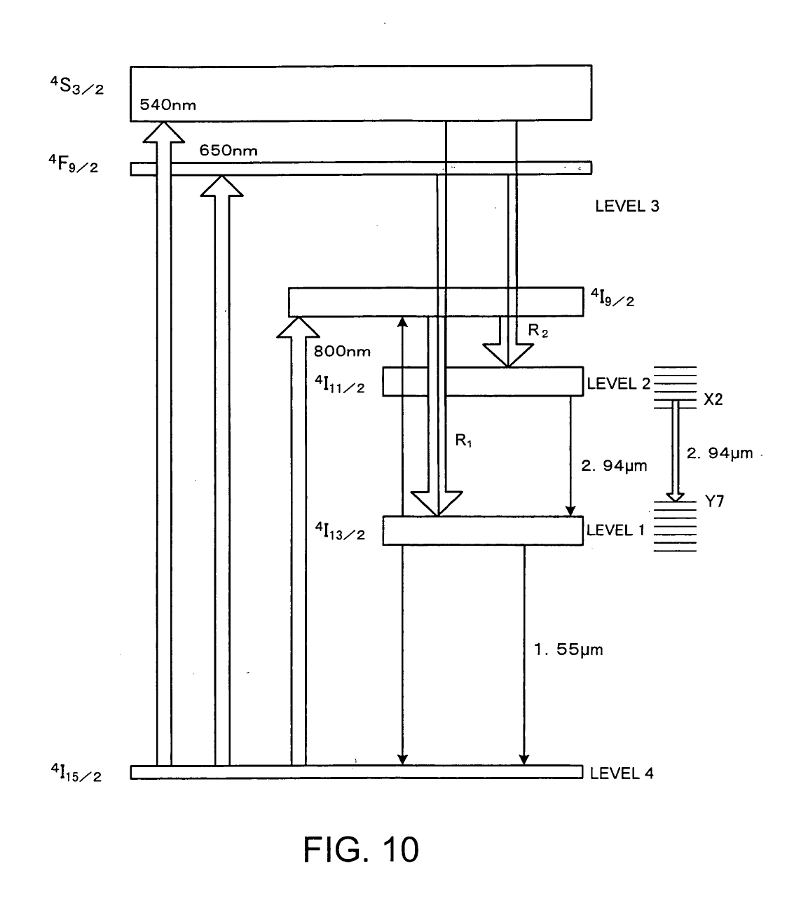

In order to facilitate understanding of this invention, Er:YAG energy levels will be described with reference to FIG. 10.

FIG. 10 shows Er:YAG energy levels along with main pumping bands. 2.94 μm laser oscillation is caused by transition from a level 2 serving as an upper level to a level 1 serving as a lower level. The level 1 also serves as an upper level in 1.55 μm transition from the level 1 to a level 4. In pumping by an excitation source such as a Xe flashlamp having a wide spectrum, Er ions are pumped from the ground level 4I_{15/2} by spectra of 540 nm, 650 nm, and 800 nm bands so as to be excited to 4S_{3/2}, 4F_{9/2}, and 4I_{9/2} energy levels, respectively. In FIG. 10, these energy levels are collectively indicated as a level 3. The level 3 is an uppermost level in a four-level laser. Er ions are distributed into the level 2 from the level 3 by a non-radiation process, thereby generating an inverse distribution between the level 2 serving as the upper level and the level 1 serving as the lower level.

In 1.55 μm oscillation as a three-level laser, the level 1 serving as an upper level is populated with a distribution caused by a non-radiation process from the level 3 and further caused by emission of 2.94 μm light from the level 2.

On the other hand, the distribution in the lower level (level 1) in 2.94 μm oscillation is reduced due to transition by a process of simultaneous light emission to the level 4 and to the 4I_{9/2} level in the level 3, which is caused by mutual relaxation of Er ions in the level 1. Further, the distribution in the level 1 is also reduced by spontaneous emission of 1.55 μm light.

As described above, since the inverse distribution between the level 2 and the level 1, particularly the population number in the level 1 serving as the lower level, depends on the reduction due to the mutual relaxation of Er ions in the level 1 and the reduction due to the spontaneous emission of light, the 2.94 μm-wavelength laser power depends on the population number in the level 1 serving as the lower level.

In this invention, the laser power is increased by providing means for reducing Er ions in the level 1 serving as the lower level through a spontaneous light emission process and another relaxation process or through a stimulated light emission process.

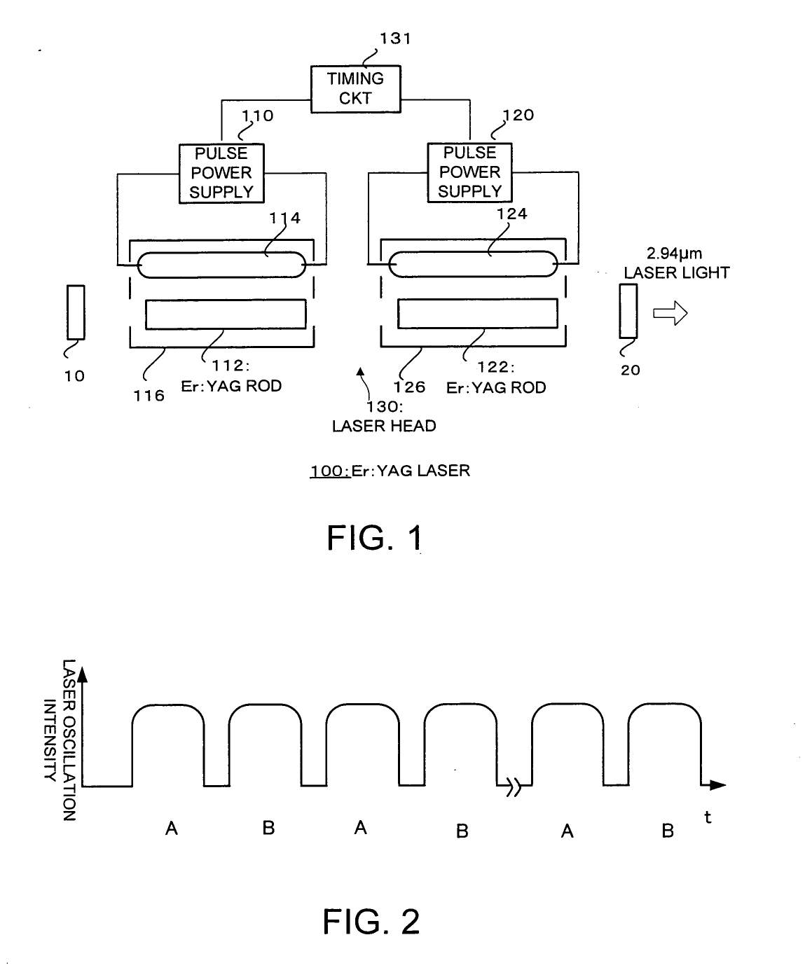

FIG. 1 is a diagram exemplarily showing the first embodiment of this invention.

In FIG. 1, a laser oscillator, or laser equipment, 100 comprises a laser head 130, a total reflection mirror 10, and an output mirror 20. The mirrors 10 and 20 are disposed at opposite ends of the laser head 130, respectively. The laser head 130 comprises two laser housings 116 and 126. An Er:YAG rod 112 and a Xe flashlamp 114 are disposed in the housing 116. The Er:YAG rod 112 receives on its side spectra emitted due to discharge of the Xe flashlamp 114 and further receives light reflected by a cavity in the housing in response to receipt of light from the flashlamp, thereby pumping Er ions from a ground level thereof. On the other hand, an Er:YAG rod 122 and a Xe flashlamp 124 are disposed in the housing 126. The Er:YAG rod 122 receives on its side spectra emitted due to discharge of the Xe flashlamp 124 and further receives light reflected by a cavity in the housing in response to receipt of light from the flashlamp, thereby pumping Er ions from a ground level thereof. The housings 116 and 126 are disposed so that the Er:YAG rods 112 and 122 are located on the same axis. The total reflection mirror 10 and the output mirror 20 are disposed perpendicular to the axis of the Er:YAG rods 112 and 122 so as to form a resonator. The total reflection mirror 10 is a reflection mirror having a reflectance of 100% with respect to the wavelength of 2.94 μm, while the output mirror 20 is a reflection mirror having a transmittance of several % with respect to the wavelength of 2.94 μm and adapted to reflect other than that.

The Xe flashlamp 114 is driven by a pulse power supply 110 so as to discharge at a predetermined repetition rate, thereby emitting excitation light. On the other hand, the Xe flashlamp 124 is driven by a pulse power supply 120 so as to discharge at a predetermined repetition rate, thereby emitting excitation light. A timing pulse circuit 131 receives timing signals of discharge current pulses of the pulse power supply 110, adjusts the timing thereof, and supplies them to the pulse power supply 120 so that discharge current pulses of the pulse power supply 120 are delayed by a predetermined time with respect to the discharge current pulses of the pulse power supply 110, respectively.

The offset between the timing of discharge current of the Xe flashlamp 114 and the timing of discharge current of the Xe flashlamp 124 is such that laser pulses generated by laser oscillation due to pumping of Er ions in the Er:YAG rod 122 by light emission of the flashlamp 124 do not overlap laser pulses generated by laser oscillation due to pumping of Er ions in the Er:YAG rod 112 by light emission of the flashlamp 114. With this configuration, for example, 100 pps or more repetitive pulse oscillations are first performed from the laser housing 116 and, likewise, 100 pps or more repetitive pulse oscillations are performed from the laser housing 126 so that pulse oscillations from the laser housing 126 are located right between pulse oscillations from the laser housing 116, respectively. As a result, 200 pps or more repetitive pulse oscillations, which is twice the original, are observed from the laser head 130. In this embodiment, the Er:YAG rods are respectively excited in a time-sharing manner, which thus can be called a time-sharing excitation system. That is, this is a system adapted to excite a plurality of predetermined laser medium spaces in a time-sharing manner, respectively.

FIG. 2 exemplarily shows a 2.94 μm-wavelength laser pulse output from the laser equipment 100 thus obtained, wherein it is exemplarily shown that the output is comprised of laser pulse oscillations A from the laser housing 116 and laser pulse oscillations B from the laser housing 126.

Using a plurality of laser housings, it is possible to temporarily stop the operation of each laser housing, thereby allowing an Er:YAG rod therein to rest. By this rest time, transition of Er ions present in the lower level (4I_{3/2}) in the laser transition to the ground level is facilitated, i.e. the population number of Er ions in the lower level (4I_{13/2}) is reduced, thereby enabling high power of laser oscillation.

In this manner, 200 W or more quasicontinuous oscillation is enabled by the combination of the number of repetitive pulse oscillations and a pulse oscillation duration.

In the foregoing embodiment, two laser housings are used. However, the number of laser housings is not limited thereto. By increasing the number of laser housings, it is possible to reduce a laser operation time of each Er:YAG rod and increase the number of pulse repetitions of the laser equipment as a whole, thereby further increasing the laser power.

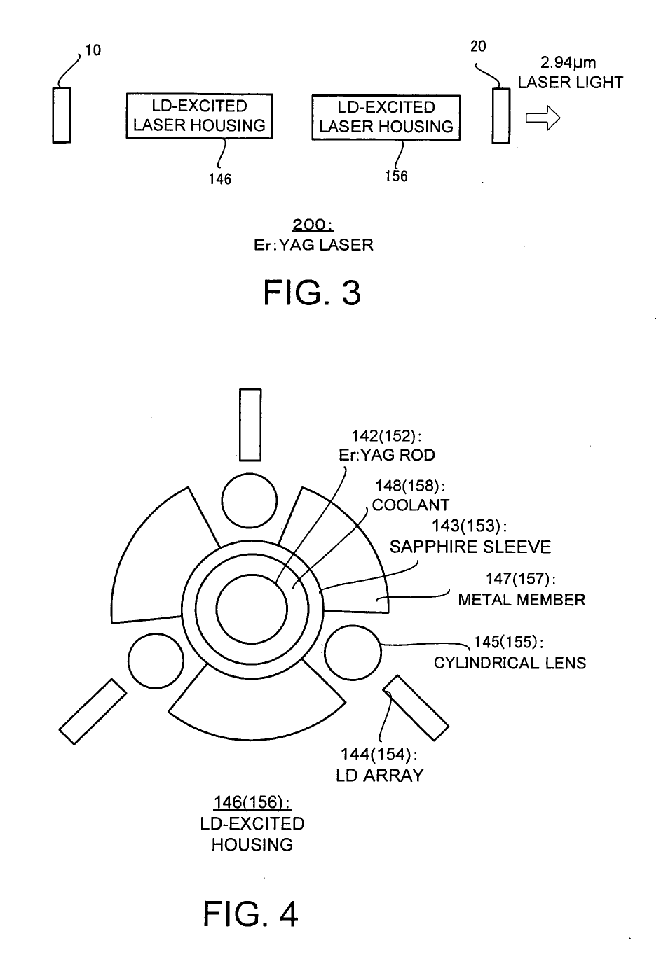

FIG. 3 is a schematic diagram showing the second embodiment of this invention.

In FIG. 3, an Er:YAG laser equipment 200 comprises laser housings 146 and 156 disposed on the same axis and a total reflection mirror 10 and an output mirror 20 which are disposed at opposite ends, respectively. The laser housings each have a structure in which an Er:YAG rod is excited by a semiconductor laser (LD). As such a housing, use can be made of a structure described in FIG. 6.67 of Non-Patent Document 2. Although a Nd:YAG rod is used in the structure of Non-Patent Document 2, an Er:YAG rod may be used instead of it in the embodiment of this invention.

FIG. 4 shows details of the semiconductor-laser-excited Er:YAG laser housing 146 or 156. Since the housing 156 has the same structure as that of the housing 146, the housing 146 will be described while the same components of the housing 156 are given in parentheses, thereby simplifying the description. FIG. 4 is a cross-sectional view of the laser housing 146 (156) taken along a line perpendicular to the axis of the laser in FIG. 3. In FIG. 4, an Er:YAG rod 142 (152) is disposed in a sapphire sleeve 143 (153) and a coolant 148 (158) flows in a space defined between the inner periphery of the sapphire sleeve and the outer periphery of the laser rod. Metal members 147 (157) hold the sapphire sleeve from three directions. Semiconductor laser arrays 144 (154) are disposed such that, in each array 144 (154), many semiconductor lasers are arrayed along the axis of the laser rod in a direction perpendicular to the sheet surface. Cylindrical lenses 145 (155) are each disposed in a slot defined between the metal members and each extend parallel to the laser rod. The cylindrical lenses focus laser light from the semiconductor laser arrays 144 (154) and irradiate it onto the laser rod on its side from three directions. As a wavelength of each semiconductor laser, a selection can be made of a wavelength that can achieve excitation to the 4I_{1/2} level or the 4I_{11/2} level. The semiconductor laser arrays 144 disposed in three directions are controlled to perform pulse oscillation simultaneously with each other. The three semiconductor laser arrays 154 in the laser housing 156 are also controlled to perform pulse oscillation simultaneously with each other. However, in the latter case, the light emission timing is offset so that light emission is performed after completion of light emission of the former. In this manner, by offsetting the oscillation timings of the semiconductor laser arrays, the Er:YAG rods subjected to pumping by the semiconductor laser light are switched so that the 2.94 μm laser output from the Er:YAG laser equipment is comprised of oscillation pulses A and B from the respective laser rods like that shown in FIG. 3.

Also in this embodiment, by increasing the number of laser housings to reduce a time in which the Er:YAG rod of each housing contributes to oscillation, it is possible to reduce the distribution in the laser lower level to thereby increase contribution to the next laser oscillation.

Now, the third embodiment of this invention will be described. Although, in the first and second embodiments, the description has been made of the case where the plurality of laser housings are used, the principle of this invention can also be used even in the case of a single laser housing. That is, since this invention divides an Er:YAG laser medium space into a plurality of regions and pumps the respective regions in an excitation time sharing manner, i.e. not pumping each of them constantly, it is sufficient to pump respective predetermined portions of a single laser rod along the resonator axis direction thereof in a time sharing manner.

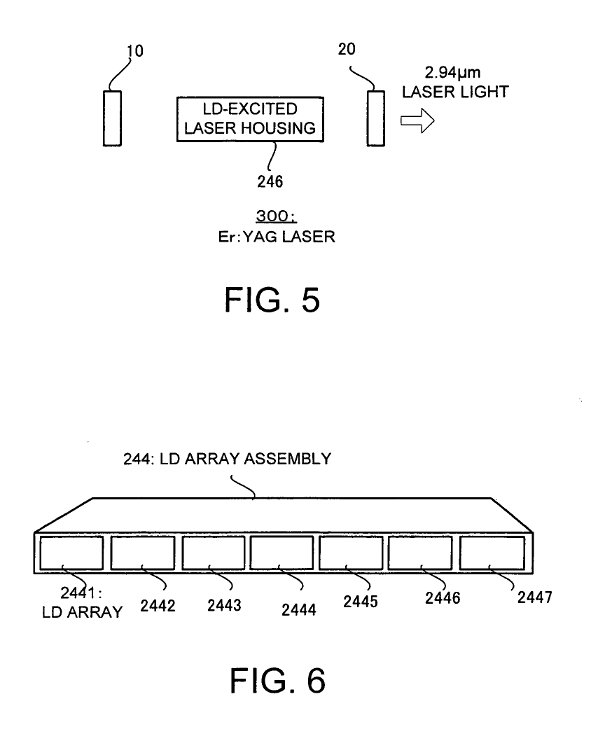

FIG. 5 is a schematic diagram of the third embodiment. In FIG. 5, a laser housing 246 is a semiconductor-excited laser housing. The structure of this housing is similar to that of the LD-excited laser housing 146 of the second embodiment shown in FIG. 4. The difference from FIG. 4 lies in that a semiconductor laser array assembly 244 is used instead of the semiconductor laser arrays 144. Hereinbelow, this difference will be described.

FIG. 6 is a perspective view showing the semiconductor laser array assembly 244. The assembly 244 is composed of semiconductor laser arrays 2441 to 2447 arranged in a longitudinal direction thereof. Each semiconductor laser array has a plurality of semiconductor lasers (LDs) that are arrayed so that individual light-emitting surfaces thereof are oriented in the same direction. The LDs of each semiconductor laser array are simultaneously supplied with current and simultaneously oscillate. However, the respective semiconductor laser arrays are supplied with current so as to oscillate at timings different from each other. That is, the current is supplied to the semiconductor laser arrays 2441 to 2447 by offsetting the phase. For example, by supplying current pulses to the semiconductor laser array 2441 for a predetermined time, then supplying current pulses to the semiconductor laser array 2442 at the timing of falling of the last current pulse to the semiconductor laser array 2441, and then switching supply of current pulses to the subsequent semiconductor laser arrays in sequence, oscillation light from the semiconductor laser array assembly 244 is switched per array in sequence accordingly. Therefore, the position in a longitudinal direction of an Er:YAG rod subjected to pumping light from its side by the LDs of the semiconductor laser array assembly 244 moves from a position near an end surface of the rod toward its opposite end surface in sequence. Accordingly, since the position, adapted to contribute to laser oscillation, of the Er:YAG rod is spatially switched in the axial direction of the rod, the distribution of Er ions in the lower level continues to decrease in each space until contribution to the next laser operation. In this embodiment, the description has been made of the case where the number of LD arrays is seven in the axial direction. However, the number of LD arrays is not limited thereto and may be two or more. By increasing the number of LD arrays, the region, adapted to directly contribute to oscillation, of the laser rod per unit time is reduced and hence the peak of 2.94 μm oscillation pulses is lowered. However, it is considered that this point can be solved by irradiating pumping pulses each having a small pulse width and a large peak value from the individual LDs.

In the foregoing embodiments, by properly adjusting the pulse width, the pulse interval, and the pulse amplitude of pumping pulses to be irradiated onto the respective regions of the laser medium and further adjusting the phase of these pulses between the respective regions, it is possible to increase the 2.94 μm-wavelength energy per unit time from the Er:YAG laser. By these adjustments, it can also be expected to obtain the quasicontinuous laser output.

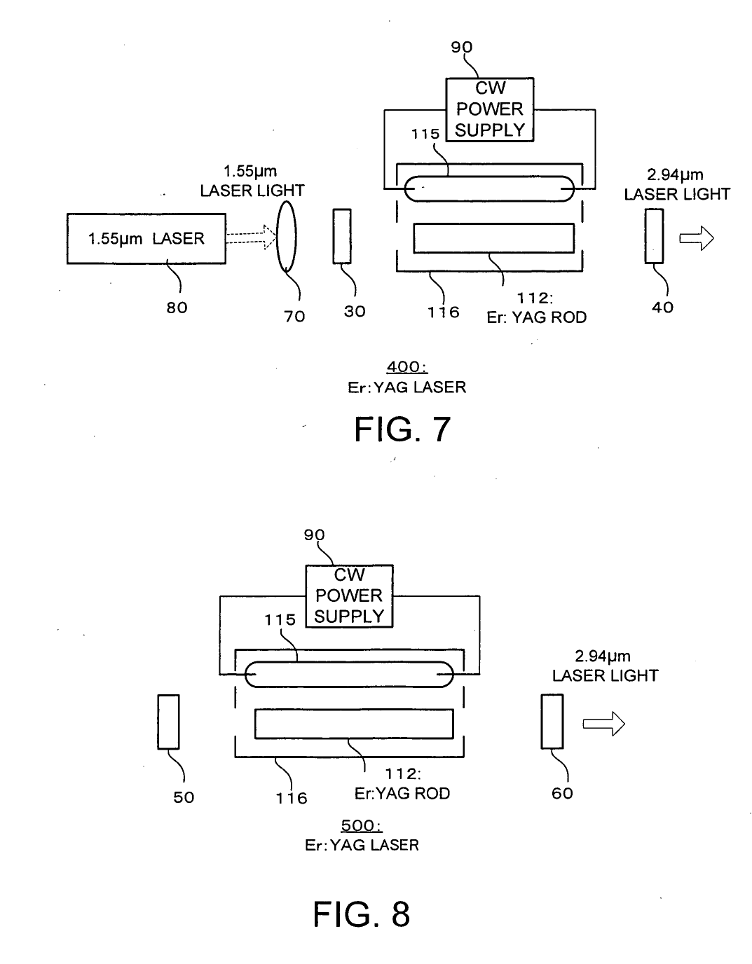

FIG. 7 is a schematic diagram of the fourth embodiment of this invention. In the foregoing embodiments, the reduction of the distribution in the lower level in the 2.94 μm transition mainly depends on spontaneous decay from that level. On the other hand, this embodiment intends to positively reduce the distribution in the lower level. In FIG. 7, a 2.94 μm-wavelength Er:YAG laser equipment 400 comprises a CW power supply 90 for supplying continuous discharge current to a Kr arc lamp 115, an Er:YAG rod 112 and the Kr arc lamp 115 disposed in a housing 116, and a reflection mirror 30 and an output mirror 40 disposed at opposite ends of the laser rod and forming a resonator. Further, an Er:YAG laser equipment 80 adapted to oscillate 1.55 μm-wavelength laser light is disposed behind the reflection mirror 30. 1.55 μm laser light is irradiated onto an end surface of the Er:YAG rod 112 from the laser 80 through a collimating optical system 70. The reflection mirror 30 is coated so as to have a reflectance of approximately 100% with respect to the wavelength of 2.94 μm and a transmittance near 100% with respect to the wavelength of 1.55 μm. In this embodiment, laser oscillation of the laser equipment may be either pulse oscillation or continuous oscillation. Since the lower level in 2.94 μm-wavelength laser oscillation is the upper level in 1.55 μm transition, this embodiment introduces 1.55 μm laser light from the exterior to reduce the distribution in this level by stimulated emission, thereby achieving an increase in power of 2.94 μm laser oscillation output.

Now, the fifth embodiment of this invention will be described. As described before, the oscillation wavelengths of the Er:YAG lasers are 1.55 μm and 2.94 μm, wherein the lower level (4I_{13/2}) in 2.94 μm laser transition is the upper level (4I_{13/2}) in 1.55 μm laser transition. Therefore, if 1.55 μm laser oscillation is enabled simultaneously with 2.94 μm laser oscillation, an increase in population number of Er ions accumulated into the lower level due to 2.94 μm laser transition can be reduced by transition of Er ions, through moderate 1.55 μm laser oscillation, to the ground level (4I_{15/2}) from the upper level (4I_{13/2}) in 1.55 μm transition which is common to the lower level (4I_{13/2}) in 2.94 μm transition.

FIG. 8 is a schematic diagram showing the fifth embodiment of this invention.

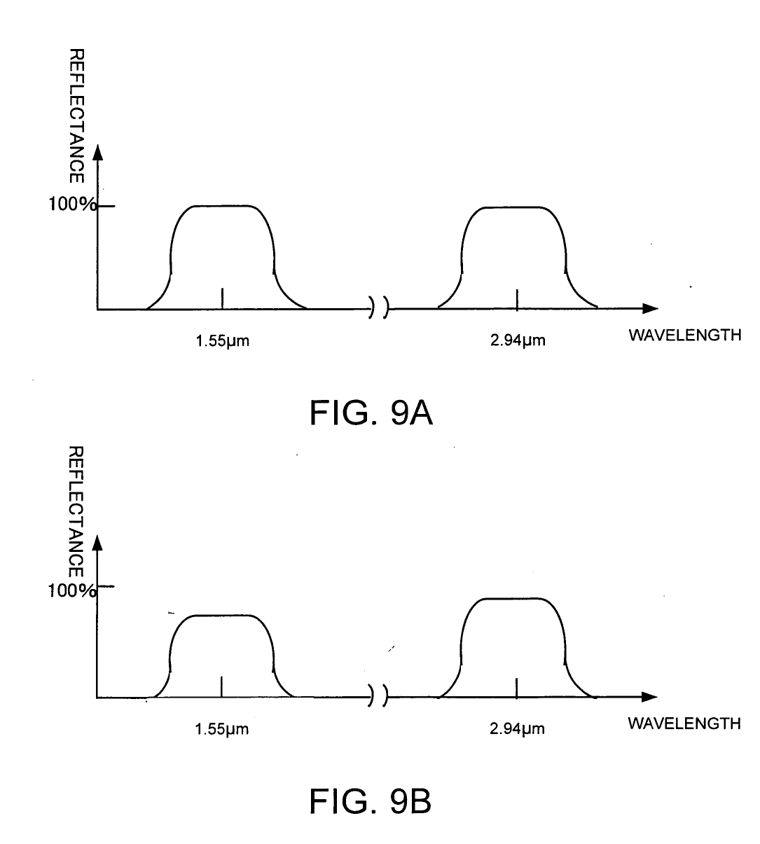

In FIG. 8, an Er:YAG laser equipment 500 comprises an Er:YAG rod 112 and a Kr arc lamp 115 disposed in a housing 116, a reflection mirror 50, and an output mirror 60. The arc lamp 115 is continuously supplied with the power from a CW power supply 90 to carry out arc discharge. The reflection mirror 50 is a total reflection mirror adapted to exhibit reflectances of approximately 100% with respect to wavelengths of 1.55 μm and 2.94 μm as shown in FIG. 9A. On the other hand, the output mirror 60 exhibits a reflectance of about 95% with respect to the wavelength of 2.94 μm, while it exhibits a reflectance with respect to the wavelength of 1.55 μm that does not impede 2.94 μm laser oscillation. For example, as shown in FIG. 9B, the reflectances are set to 95% with respect to the wavelength of 2.94 μm and to about 90% with respect to the wavelength of 1.55 μm. In this manner, by allowing oscillation at the two wavelengths, it is possible to more easily achieve increased-power and continuous 2.94 μm laser oscillation.

Since the lower level in 2.94 μm-wavelength transition is simultaneously the upper level in 1.55 μm-wavelength transition, by simultaneously allowing oscillation at the wavelengths of 1.55 μm and 2.94 μm, it is possible to reduce the distribution in the lower level in 2.94 μm-wavelength transition to thereby increase the inverse distribution between the upper and lower levels in 2.94 μm oscillation, thus enabling an increase in 2.94 μm laser power.

In the foregoing embodiment, the description has been made of the case of continuous pumping by the use of the Kr arc lamp. However, it is also effective in the case of pumping by the use of a semiconductor laser array. Particularly, if a selection is made, as an oscillation wavelength of semiconductor lasers, a wavelength that directly pumps Er ions from the ground level 4I_{15/2} to the 4I_{11/2} level, since the pumping is concentrated to the 4I_{11/2} level, the distribution in the 4I_{13/2} level can be further reduced due to stimulated emission by setting the reflectance of an output mirror to 100% with respect to the wavelength of 1.55 μm to increase the 1.55 μm laser light intensity in a laser resonator.

1. An Er:YAG laser equipment comprising an Er:YAG crystal medium and optical pumping means and adapted to oscillate at a wavelength of 2.94 μm, wherein the optical pumping means irradiates pumping light pulses onto a plurality of regions of the Er:YAG crystal medium from its side at timings offset from each other, the plurality of regions located along a longitudinal direction of the Er:YAG crystal medium.

2. An Er:YAG laser equipment according to claim 1, wherein the timings of the pumping light pulses are offset from each other such that the pumping light pulses do not overlap each other.

3. An Er:YAG laser equipment according to claim 2, wherein the pumping light pulses having a predetermined period are irradiated onto the plurality of regions of the Er:YAG crystal medium, respectively.

4. An Er:YAG laser equipment according to claim 1, wherein the pumping light pulses are irradiated onto the plurality of regions of the Er:YAG crystal medium in a time-sharing manner, respectively.

5. An Er:YAG laser equipment according to claim 1, wherein the plurality of regions of the Er:YAG crystal medium include Er:YAG rods, respectively, and the optical pumping means comprises optical pumping sources corresponding to the Er:YAG rods, respectively.

6. An Er:YAG laser equipment according to claim 1, wherein the optical pumping means is a Xe flashlamp adapted to perform pulse discharge operation.

7. An Er:YAG laser equipment according to claim 1, wherein the optical pumping means is a pulse-driven semiconductor laser array.

8. An Er:YAG laser equipment comprising an Er:YAG crystal medium and optical pumping means and adapted to oscillate at a wavelength of 2.94 μm, wherein Er:YAG laser light having a wavelength of 1.55 μm is injected into the Er:YAG crystal medium from a laser-oscillation axial direction.

9. An Er:YAG laser equipment comprising an Er:YAG crystal medium, optical pumping means, and a first and a second reflection mirror disposed at opposite ends of the Er:YAG crystal medium, the Er:YAG laser adapted to oscillate at a wavelength of 2.94 μm, wherein the first and second reflection mirrors form a resonator with respect to the wavelength of 2.94 μm and a wavelength of 1.55 μm and laser light having the wavelength of 2.94 μm is output from the second reflection mirror.

10. An Er:YAG laser equipment according to claim 4, wherein the plurality of regions of the Er:YAG crystal medium include Er:YAG rods, respectively, and the optical pumping means comprises optical pumping sources corresponding to the Er:YAG rods, respectively.

11. An Er:YAG laser equipment according to claim 4, wherein the optical pumping means is a Xe flashlamp adapted to perform pulse discharge operation.

12. An Er:YAG laser equipment according to claim 4, wherein the optical pumping means is a pulse-driven semiconductor laser array.
